(19) United States
(12) Patent Application Publication
(10) Pub. No.: US 2008/0207153 A1
(43) Pub. Date: Aug. 28, 2008

(54) Tuner

(76) Inventor: Seok Dong Choi, Dong-gu (JP)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/910,165

(22) PCT Filed: Oct. 27, 2006
(86) PCT No.: PCT/KR2006/004412

§ 371 Date: Sep. 28, 2007

(30) Foreign Application Priority Data
Oct. 28, 2005 (KR) 10-2005-0102551

(51) Int. Cl. H04B 1/18

(52) U.S. Cl. 455/200.1

(57) ABSTRACT

Provided is a tuner, which comprises: an amplifier for amplifying received signals; a synchronization processor for mixing the received signals with oscillating frequency signals to output intermediate frequency signals of a selected channel; an intermediate frequency signal processor for filtering and amplifying the intermediate frequency signals; a demodulator for demodulating the amplified intermediate frequency signals and detecting intensity of the signals to output a gain control signal; and an attenuator for attenuating intensity of the received signals in response to the gain control signal.

### TECHNICAL FIELD

The present invention relates to a tuner.

### BACKGROUND ART

FIG. 1 is a schematic block diagram of elements of a tuner 20 used for a ground wave broadcasting system of a related art.

Referring to FIG. 1, the tuner 20 used for the ground wave broadcasting system of a related art includes a band pass filter 21 connected to an antenna 10, a low noise amplifier 22, a synchronization processor 23, an intermediate frequency signal processor 24, and a demodulator 25 (the demodulator 25 can be installed in an outside depending on a kind of the tuner).

The band pass filter 21 selectively filters only radio frequency (RF) signal corresponding to a broadcasting band region, and the low noise amplifier 22 suppresses a noise component to amplify the selectively filtered RF signal.

The synchronization processor 23 tunes an RF signal corresponding to a selected channel to create an intermediate frequency (IF) signal, and the intermediate frequency signal processor 24 filters/amplifies IF signals.

The demodulator 25 decodes the IF signals into baseband signals to create audio/video data. At this point, the demodulator 25 detects intensity of the IF signals and delivers a gain control signal to the intermediate frequency signal processor 24 and the synchronization processor 23.

That is, the demodulator 25 delivers an RF gain control (RF AGC) signal to the synchronization processor 23, and delivers an IF gain control (IF AGC) signal to the intermediate frequency signal processor 24 to control power of each signal.

The above-described related art gain control method is a dual type method, which can be generally used only for signals in a medium electric field and a weak electric field region. In the case where signals in a strong electric field is received via an antenna, a problem may be generated in processing the signals.

According to a related art dual type gain control type method, even when the synchronization processor 23 and the intermediate frequency signal processor 24 control power of received signals together, it is almost impossible to dynamically process signals of a strong electric field having a region of (−)30-(−)70 dB.

When the signals of a strong electric field are received as described above, mixed modulated signals generated at a phase synchronization circuit, a mixer provided within the synchronization processor 24, and an intermediate frequency signal amplifier provided within the intermediate frequency signal processor 24 reduce reception performance of the tuner.

Also, a saturation phenomenon caused by the signals of a strong electric field can be generated at the low noise amplifier 23, the intermediate frequency signal amplifier, and the mixer. The saturation phenomenon also acts as a factor of reducing reception performance of the tuner.

Therefore, there emerges a need of extending an input dynamic range of received signals that can be processed by the tuner.

### DISCLOSURE OF INVENTION

### Technical Problem

The present invention provides a tuner capable of stably processing received signals.

The present invention provides a tuner capable of attenuating signals of a strong electric field.

The present invention provides a tuner capable of extending an input dynamic range of received signals.

### Technical Solution

In the embodiment of the invention, there is provided a tuner comprising: an amplifier for amplifying received signals; a synchronization processor for mixing the received signals with oscillating frequency signals to output intermediate frequency signals of a selected channel; an intermediate frequency signal processor for filtering and amplifying the intermediate frequency signals; a demodulator for demodulating the amplified intermediate frequency signals and detecting intensity of the signals to output a gain control signal; and an attenuator for attenuating intensity of the received signals in response to the gain control signal.

In the embodiment of the invention, there is provided a tuner comprising: a first amplifier for amplifying received signals; an attenuator for attenuating the signals amplified at the first amplifier; a first filter for passing signals in a selected band from signals received from the attenuator; a mixer for mixing signals received from the first filter with oscillating frequency signals to output intermediate frequency signals; a phase synchronization circuit for providing the oscillating frequency signals to the mixer and providing a gain control signal to the first filter; a second filter for removing a noise from the intermediate frequency signals received from the mixer; a second amplifier for amplifying the intermediate frequency signals received from the second filter; and a demodulator for demodulating the intermediate frequency signals received from the second amplifier, detecting intensity of the intermediate frequency signals, and creating a gain control signal to provide the gain control signal to the attenuator, the phase synchronization circuit, and the second amplifier.

### ADVANTAGEOUS EFFECTS

A tuner according to the present invention can stably process received signals.

Also, a tuner according to the present invention can attenuate signals of a strong electric field.

Also, a tuner according to the present invention can extend a dynamic range of received signals.

### BRIEF DESCRIPTION OF THE DRAWINGS

FIG. 1 is a schematic block diagram illustrating elements of a tuner 20 used for a ground wave broadcasting system of a related art;

FIG. 2 is a view of a tuner according to an embodiment of the present invention;

FIG. 3 is a graph illustrating a correlation between an electric field region and power amplification values of received signals processed at a tuner according to an embodiment of the present invention;

FIG. 4 is a circuit diagram illustrating an attenuator of a tuner is realized using a pin diode according to an embodiment of the present invention;

FIG. 5 is a graph illustrating a current characteristic of a pin diode provided to an attenuator of a tuner mounting a strong electric field input compensating circuit therein according to an embodiment of the present invention; and

FIG. 6 is a view illustrating an attenuator of a tuner according to another embodiment of the present invention.

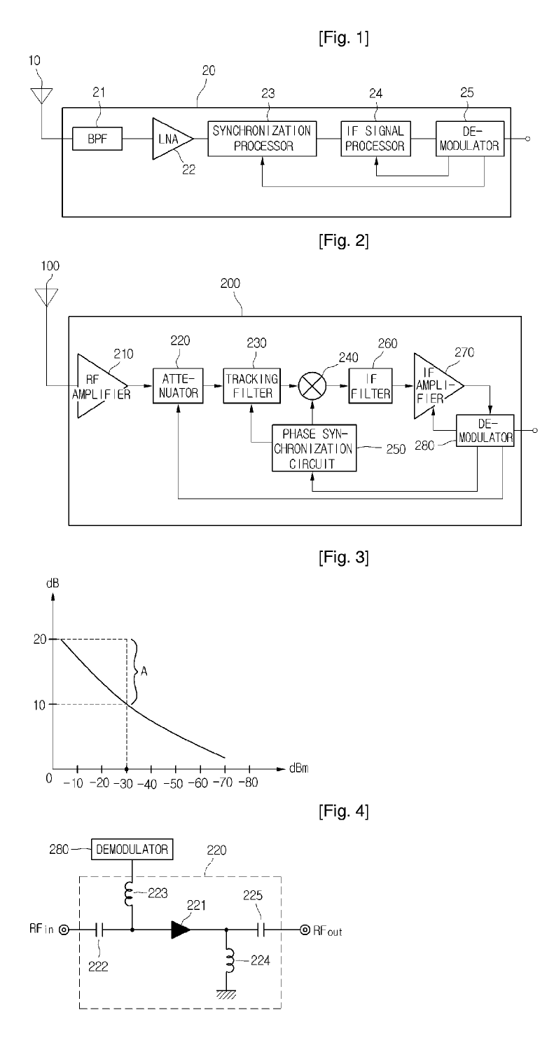

### BEST MODE FOR CARRYING OUT THE INVENTION

Reference will now be made in detail to the preferred embodiments of the present invention, examples of which are illustrated in the accompanying drawings.

FIG. 2 is a view of a tuner according to an embodiment of the present invention;

The embodiment illustrated in FIG. 2 shows a tuner applied to a ground wave broadcasting receiving system which performs a decoding operation using orthogonal frequency division multiplexing (OFDM) or vestigial side bands (VSB). However, a tuner according to the present invention can be applied not only to a ground wave broadcasting system but also to other type receiving system.

Referring to FIG. 2, the tuner 200 according to an embodiment of the present invention includes an RF amplifier 210, an attenuator 220, a tracking filter 230, a mixer 240, a phase synchronization circuit (phase locked loop: PLL) 250, an intermediate frequency (IF) filter 260, an IF amplifier 270, and a demodulator 280.

The antenna 100 can be a reflection plate antenna or a flat plate antenna using a microstrip line. The reflection plate antenna or flat plate antenna has a high gain characteristic and a circularly polarized wave characteristic (broadcasting wave has a circularly polarized characteristic), and has advantages of a small size and being cheap, and being easily manufactured.

The RF amplifier 210 amplifies an RF signal of a ground wave broadcasting band that is received via the antenna 100. A related art RF amplifier has amplified power to 10 dB or less in order to realize an optimum reception sensitivity. This is for excluding a processing problem of signals having a strong electric field generated at the RF amplifier 210, that is, signal distortion and an electromagnetic wave interference effect.

However, according to a tuner of the present invention, the attenuator 220 is provided, so that the RF amplifier 210 can amplify power up to a range of 15-20 dB. A function of the attenuator 220 will be described below in detail.

The tracking filter 230 removes a noise component included in an RF signal (high frequency signal) of a ground wave broadcasting band and filters only a corresponding RF signal.

A synchronization processor mixing the RF signal with an oscillating frequency signal to output an IF signal, and outputting an IF signal corresponding to a set channel includes the mixer 240 and the phase synchronization circuit 250.

The mixer 240 mixes an RF signal that has passed through the tracking filter 230 with an oscillating frequency signal to output an IF signal.

The phase synchronization circuit 250 synchronizes a channel input by a user with a corresponding frequency signal and converts the channel, and delivers a predetermined oscillating frequency to the mixer 240. The phase synchronization circuit 250 includes an oscillator for creating an oscillating frequency.

An IF signal processor for filtering and amplifying IF signals includes the IF filter 260 and the IF amplifier 270.

The IF filter 260 removes a noise component of an IF signal to filter only an IF signal component, and the IF amplifier 270 amplifies the IF signal to a size that can be processed by the demodulator 280.

The demodulator 280 demodulates the amplified IF signal using OFDM or VSB to create transport stream (TS) data.

Also, the demodulator 280 detects intensity of the IF signal to create a gain control signal, and delivers the gain control signal to the IF amplifier 270 and the phase synchronization circuit 250, thereby controlling intensity of signals. At this point, an IF gain control (IF AGC) signal is delivered to the IF amplifier 270, and an RF gain control (RF AGC) signal is delivered to the phase synchronization circuit 250, which delivers the RF AGC signal to the tracking filter 230.

Through this process, a gain is automatically controlled depending on a strength of a high frequency input signal applied to the demodulator 280, and thus the demodulator 280 receives an IF signal of a constant level.

Since the above-described dual auto gain control (AGC) has a correlation with an electric field strength of an amplification terminal, the dual AGC is used in a medium electric field region and a weak electric field region. According to the present invention, the attenuator 220 is further provided, so that an RF AGC signal is delivered from the demodulator 280 and triple AGC is performed. Accordingly, the tuner can operate without limitation even in a strong electric field region.

FIG. 3 is a graph illustrating a correlation between an electric field region and power amplification values of received signals processed at a tuner 200 according to an embodiment of the present invention.

Referring to FIG. 3, as described above, received signals in a medium electric field region of (−)30-(−)70 dBm or a weak electric field region of (−) 70 dBm or less are amplified to 10 dB or less in a related art. On the other hand, since the attenuator 220 compensates for the received signals by a region “A” according to the present invention, the received signals do not exceed the medium electric field region even when the received signals are amplified up to 20 dB at the maximum.

Therefore, a problem by strong electric field signals at the amplification terminal is not generated.

The attenuator 220 is connected to an output terminal of the RF amplifier 210 and an input terminal of the tracking filter 230, and receives an RF AGC signal from the demodulator 280 to selectively attenuate intensity of the RF signal amplified by the RF amplifier 210.

As described above, according to the present invention, a three-stage signal control system of a terminal of the attenuator 220, a terminal of the phase synchronization circuit 250, and a terminal of an IF amplifier 270 is formed, so that an input dynamic range of signal intensity can extend even more.

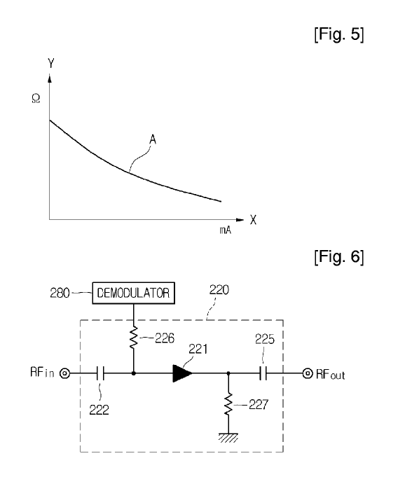

The attenuator 220 will be described below in detail with reference to FIGS. 4 and 5.

FIG. 4 is a circuit diagram illustrating an attenuator of a tuner is realized using a pin diode according to an embodiment of the present invention, and FIG. 5 is a graph illustrating a current characteristic of a pin diode provided to an attenuator of a tuner mounting a strong electric field input compensating circuit therein according to an embodiment of the present invention.

Referring to FIG. 4, the attenuator 220 includes a pin diode 221, a first capacitor 222, a second capacitor 225, a first inductor 223, and a second inductor 224.

The first capacitor 222 is connected to an output terminal of the RF amplifier 210 and to an input terminal of the pin diode 221.

The first inductor 223 has one side parallel-connected to a connection terminal of the first capacitor 222 and the pin diode 221, and the other side connected to the demodulator 280 to receive a gain control signal.

The second capacitor 225 is connected to an output terminal of the pin diode 221 and an input terminal of the tracking filter 230. The second inductor 224 is parallel-connected to a connection terminal of the second capacitor 225 and the pin diode 221.

The second inductor 224 has the other side connected to a ground terminal.

The first capacitor 222 cuts off a DC component signal to deliver a satellite signal to the pin diode 221, and the first inductor 223 allows a gain control signal delivered from the demodulator 280 to flow in only one direction to deliver the gain control signal to the pin diode 221.

The second inductor 224 allows a reversely reflected signal component to flow to the ground terminal to stably operate the attenuator 220, and the second capacitor 225 passes a satellite signal of a high frequency component having controlled intensity to allow the satellite signal to flow to the tracking filter 230.

FIG. 6 is a view illustrating an attenuator of a tuner according to another embodiment of the present invention.

Referring to FIG. 6, the attenuator 220 includes a pin diode 221, a first capacitor 222, a second capacitor 225, a first resistor 226, and a second resistor 227.

The first capacitor 222 is connected to an output terminal of the RF amplifier 210, and to an input terminal of the pin diode 221.

The first resistor 226 has one side parallel-connected to a connection terminal of the first capacitor 222 and the pin diode 221, and the other side connected to the demodulator 280 to receive a gain control signal.

The second capacitor 225 is connected to an output terminal of the pin diode 221 and an input terminal of the tracking filter 230. The second resistor 227 is parallel-connected to a connection terminal of the second capacitor 225 and the pin diode 221.

The second resistor 227 has the other side connected to a ground terminal.

The first capacitor 222 cuts off a DC component signal to deliver a satellite signal to the pin diode 221, and the first resistor 226 delivers a gain control signal delivered from the demodulator 280 to the pin diode 221.

The second resistor 227 allows a reversely reflected signal component to flow to the ground terminal to stably operate the attenuator 220, and the second capacitor 225 passes a satellite signal of a high frequency component having controlled intensity to allow the satellite signal to flow to the tracking filter 230.

Referring to FIG. 5 illustrating a current characteristic of the pin diode 221, it is revealed that high frequency resistance (Y-axis) of the pin diode 221 changes as a bias current level (X-axis) changes depending on a gain control signal.

Therefore, when the demodulator 280 that has detected that signals of a strong electric field are received transmits a gain control signal to the attenuator 220, the attenuator 220 that has received the gain control signal can control intensity of signals flowing through the tracking filter 230.

Although the preferred embodiments of the present invention have been disclosed for illustrative purpose, those skilled in the art will appreciate that various modifications, additions and substitutions can be made without departing from the scope and spirit of the invention as defined in the accompanying claims.

### INDUSTRIAL APPLICABILITY

A tuner according to the present invention can be applied to a broadcasting system.

1. A tuner comprising:
an amplifier for amplifying received signals;
a synchronization processor for mixing the received signals with oscillating frequency signals to output intermediate frequency signals of a selected channel;
an intermediate frequency signal processor for filtering and amplifying the intermediate frequency signals;
a demodulator for demodulating the amplified intermediate frequency signals and detecting intensity of the signals to output a gain control signal; and
an attenuator for attenuating intensity of the received signals in response to the gain control signal.

2. The tuner according to claim 1, wherein the attenuator is located in the signal path between the amplifier and the synchronization processor.

3. The tuner according to claim 1, wherein the synchronization processor receives the gain control signal from the demodulator and controls intensity of the amplified received signals in response to the gain control signal.

4. The tuner according to claim 1, wherein the attenuator comprises a pin diode.

5. The tuner according to claim 4, wherein the attenuator further comprises:
a first capacitors series-connected to an input terminal of the pin diode and a first inductors parallel-connected to the input terminal of the pin diode; and
a second capacitor series-connected to an output terminal of the pin diode and a second inductor parallel-connected to the output terminal of the pin diode,
wherein the first inductor at the input terminal of the pin diode is connected to the demodulator to receive the gain control signal, and the second inductor at the output terminal of the pin diode is connected to a ground terminal.

6. The tuner according to claim 4, wherein the attenuator further comprises:
a first capacitors series-connected to an input terminal of the pin diode and a first resistors parallel-connected to the input terminal of the pin diode; and
a second capacitor series-connected to an output terminal of the pin diode and a second resistor parallel-connected to the output terminal of the pin diode, a
wherein the first resistor at the input terminal of the pin diode is connected to the demodulator to receive the gain control signal, and the second resistor at the output terminal of the pin diode is connected to a ground terminal.

7. The tuner according to claim 1, wherein the intermediate frequency signal processor receives the gain control signal from the demodulator, and amplifies the intermediate frequency signals in response to the gain control signal.

8. The tuner according to claim 1, wherein the amplifier comprises a radio frequency amplifier.

9. The tuner according to claim 1, wherein the gain control signal is at least one of a radio frequency gain control signal and an intermediate frequency gain control signal.

10. The tuner according to claim 1, wherein the demodulator provides a radio frequency gain control signal to the attenuator and the synchronization processor, and provides an intermediate frequency gain control signal to the intermediate frequency signal processor.

11. A tuner comprising:
a first amplifier for amplifying received signals;
an attenuator for attenuating the signals amplified at the first amplifier;
a first filter for passing signals in a selected band from signals received from the attenuator;
a mixer for mixing signals received from the first filter with oscillating frequency signals to output intermediate frequency signals;
a phase synchronization circuit for providing the oscillating frequency signals to the mixer and providing a gain control signal to the first filter;
a second filter for removing a noise from the intermediate frequency signals received from the mixer;
a second amplifier for amplifying the intermediate frequency signals received from the second filter; and
a demodulator for demodulating the intermediate frequency signals received from the second amplifier, detecting intensity of the intermediate frequency signals, and creating a gain control signal to provide the gain control signal to the attenuator, the phase synchronization circuit, and the second amplifier.

12. The tuner according to claim 11, wherein the demodulator provides a radio frequency gain control signal to the attenuator and the phase synchronization circuit, and provides an intermediate frequency gain control signal to the second amplifier.

13. The tuner according to claim 11, wherein the attenuator comprises:
a pin diode,
a first capacitor connected between an input terminal of the pin diode and the first amplifier,
a second capacitor connected between an output terminal of the pin diode and the first filter,
a first inductor connected between the demodulator and the input terminal of the pin diode, and
a second inductor connected between the output terminal of the pin diode and a ground terminal.

14. The tuner according to claim 11, wherein the attenuator comprises:
a pin diode,
a first capacitor connected between an input terminal of the pin diode and the first amplifier,
a second capacitor connected between an output terminal of the pin diode and the first filter,
a first resistor connected between the demodulator and the input terminal of the pin diode, and
a second resistor connected between the output terminal of the pin diode and a ground terminal.

15. The tuner according to claim 11, wherein the first amplifier amplifies radio frequency signals.

16. The tuner according to claim 11, wherein the first filter comprises a tracking filter.

17. The tuner according to claim 11, wherein the second filter comprises an intermediate frequency filter, and the second amplifier comprises an intermediate frequency amplifier.

18. The tuner according to claim 11, wherein the gain control signal is at least one of a radio frequency gain control signal and an intermediate frequency gain control signal.
